(19) United States
(12) Patent Application Publication
(10) Pub. No.: US 2025/0379854 A1
(43) Pub. Date: Dec. 11, 2025

(54) SYSTEMS AND TECHNIQUES FOR ANONYMOUS DATA TRANSFERS

(71) Applicant: Apple Inc., Cupertino, CA (US)

(72) Inventors: Stacey R. Abrams, Portland, OR (US); Akila Suresh, San Jose, CA (US); Manimozhi Alagarsamy, San Jose, CA (US); Manoj K. Thulaseedharan Pillai, Cupertino, CA (US); Skylar P. Peterson, Cupertino, CA (US); Richard W. Heard, San Francisco, CA (US); Pablo Pons Bordes, Redwood City, CA (US); Ashish C. Nagre, Sunnyvale, CA (US); Corey G. Fugman, San Jose, CA (US); William M. Lindemann, San Carlos, CA (US); Muhammad Noman, Santa Clara, CA (US)

(73) Assignee: Apple Inc., Cupertino, CA (US)

(21) Appl. No.: 18/894,974

(22) Filed: Sep. 24, 2024

Related U.S. Application Data
(60) Provisional application No. 63/656,521, filed on Jun. 5, 2024.

(51) Int. Cl. H04L 9/40

(52) U.S. Cl. CPC H04L 63/0421; H04L 63/0442; H04L 63/0823

(57) ABSTRACT

A method of performing an anonymous data transfer may include transmitting a transfer request associated with a desired data transfer to a first computing system. The transfer request may include a sender identifier (ID). The method may include receiving, by the application executed on the user device transfer approval indicating that the desired data transfer is approved. The method may include receiving the acceptance packet indicating that the desired data transfer is accepted and may include a recipient ID. The method may include transmitting at least a portion of the acceptance packet to the first computing system. The method may include receiving, a transfer confirmation confirming that the desired data transfer is based at least in part on the acceptance packet and/or the transfer approval.

### CROSS REFERENCE TO RELATED APPLICATION

This application is related to the following concurrently filed and commonly assigned U.S. nonprovisional patent applications: U.S. nonprovisional patent application No. 63/656,521, Filed Jun. 5, 2024, and U.S. nonprovisional patent application No. 63/656,419, Filed Jun. 5, 2024, each of which is hereby incorporated by reference in its entirety for all purposes.

### BACKGROUND

Systems for peer-to-peer data transfers generally require knowledge of both the sending and receiving parties. If, however, the parties do not have access to the other party's information, the data transfer may not be completed. In other words, the peer-to-peer data transfer may require prior knowledge of various data associated with each party to be known by the other party. In some instances, however, one party may wish to transfer data to another party without sharing some or all of their data and information.

### BRIEF SUMMARY

A method of performing an anonymous data transfer may include transmitting, by an application executed on a user device, a transfer request associated with a desired data transfer to a first computing system. The transfer request may include a sender identifier (ID). The method may include receiving, by the application executed on the user device, a transfer approval from the first computing system, the transfer approval indicating that the desired data transfer is approved. The method may include receiving, by the application executed on the user device, an acceptance packet from a recipient device, the acceptance packet indicating that the desired data transfer is accepted and may include a recipient ID. The operations may include transmitting, by the application executed on the user device, at least a portion of the acceptance packet to the first computing system. The operations may include receiving, by the application executed on the user device, a transfer confirmation confirming that the desired data transfer is based at least in part on the acceptance packet and/or the transfer approval.

A system may include one or more processors and a computer-readable medium including instructions that, when executed by the one or more processors, cause the one or more processors to perform operations. According to the operations, the system may transmit, by an application executed on a user device, a transfer request associated with a desired data transfer to a first computing system. The transfer request may include a sender ID. The system may receive, by the application executed on the user device, a transfer approval from the first computing system, the transfer approval indicating that the desired data transfer is approved. The system may receive, by the application executed on the user device, an acceptance packet from a recipient device, the acceptance packet indicating that the desired data transfer is accepted and may include a recipient ID. The system may transmit, by the application executed on the user device, at least a portion of the acceptance packet to the first computing system. The system may receive, by the application executed on the user device, a transfer confirmation confirming that the desired data transfer is based at least in part on the acceptance packet and/or the transfer approval.

A non-transitory computer-readable medium may include instructions that when executed by the one or more processors, cause the one or more processors to perform operations. The operations may include transmitting, by an application executed on a user device, a transfer request associated with a desired data transfer to a first computing system. The transfer request may include a sender identifier (ID). The operations may include receiving, by the application executed on the user device, a transfer approval from the first computing system, the transfer approval indicating that the desired data transfer is approved. The operations may include receiving, by the application executed on the user device, an acceptance packet from a recipient device, the acceptance packet indicating that the desired data transfer is accepted and may include a recipient ID. The operations may include transmitting, by the application executed on the user device, at least a portion of the acceptance packet to the first computing system. The operations may include receiving, by the application executed on the user device, a transfer confirmation confirming that the desired data transfer is based at least in part on the acceptance packet and/or the transfer approval.

### BRIEF DESCRIPTION OF THE DRAWINGS

FIG. 1 illustrates a system and a process for performing an anonymous peer-to-peer data transfer, according to certain embodiments.

FIGS. 2A-2F illustrate a system for performing an anonymous P2P data transfer, according to certain embodiments.

FIG. 3 illustrates a flowchart of a method for performing an anonymous P2P data transfer, according to certain embodiments.

FIG. 4 illustrates an example architecture or environment configured to implement techniques relating to providing route management, according to certain embodiments.

### DETAILED DESCRIPTION

Data transfers from a sender to a recipient are commonplace in society. For example, a sender may wish to send an image or other data to a recipient. Data transfers such as image transfers may be performed by email, with the sender providing a link to a resource to the recipient, sending the resource or image directly to the recipient, or other similar method. For more sensitive data, a third-party may be involved. For example, the sender may provide the recipient's account information to the third-party such that the third-party may perform the data transfer. As technology has advanced, other methods of data transfers have been developed. These peer-to-peer transfers may be performed, in some cases, directly by user devices communicating with one another instead of emails being exchanged etc.

Whether email, third-party data transfers, or peer-to-peer transfers, all of these methods of data transfers may require at least the sender to have information about the recipient. Providing a link to a resource may require that the sender have at least the recipient's email. A third-party transfer may require that the sender have at least the recipient's account number. A peer-to-peer transfer may require that the sender have at least the recipient's user device number, email, or other identifier to complete the data transfer. In some instances, however, the sender and/or the receiver may not wish to provide identifying information to the other party, but may still wish to transfer data.

A data transfer may be a transaction made between a sender and a recipient using respective user devices. If the sender and the recipient are friends (or acquaintances, etc.), the sender and the recipient may already have at least some identifying information and/or not mind sharing identifying information with the other party. Thus, the transaction may be completed using a peer-to-peer (P2P) process using the user devices. However, if the two parties wish to remain anonymous to each other, P2P may not be available. Instead, the transaction may require additional software and/or hardware components added to one or both user devices. The other methods, described above, may require identifying information to be exchanged (e.g., and email address). Thus, there is a need to enable P2P data transfers while maintaining the anonymity of the parties involved.

One solution may be to utilize a quote and encrypted acceptance packet to perform an anonymous P2P data transfer. A sender device may receive an input indicating that a user thereof wishes to perform a data transfer. The input may identify an amount of data to be transferred, specific data to be transferred, and other such information. The sender device may transmit a data transfer request to a computing system. The computing system may then verify that the data transfer request is authentic and/or possible by making one or more application programming interface (API) calls to one or more services and/or systems. After verifying the data transfer request, the computing system may transmit a transfer approval to the sender device.

Then, the sender device may communicate with a recipient device. For example, the sender device and the recipient device may communicate via near field communication (NFC), triggered by the sender device and the recipient device being brought into a certain proximity with one another. The sender device may then transmit some or all of the transfer approval to the recipient device. The recipient device may then transmit an acceptance packet, encrypted with a public-private key. The acceptance packet may identify the recipient device, account information associated therewith, a user ID, and other information. The sender device may then transmit the acceptance packet and/or the quote to the computing system. The computing system may then complete the data transfer. The sender device may then display a confirmation message based at least in part on information included in the acceptance packet. Because the acceptance packet is encrypted, the sender device may not be able to identify the recipient device (or a user thereof). Similarly, the recipient device may never receive any identifying information associated with the sender device. Thus, the P2P data transfer may be completed while maintaining the anonymity of both the sender and the receiver.

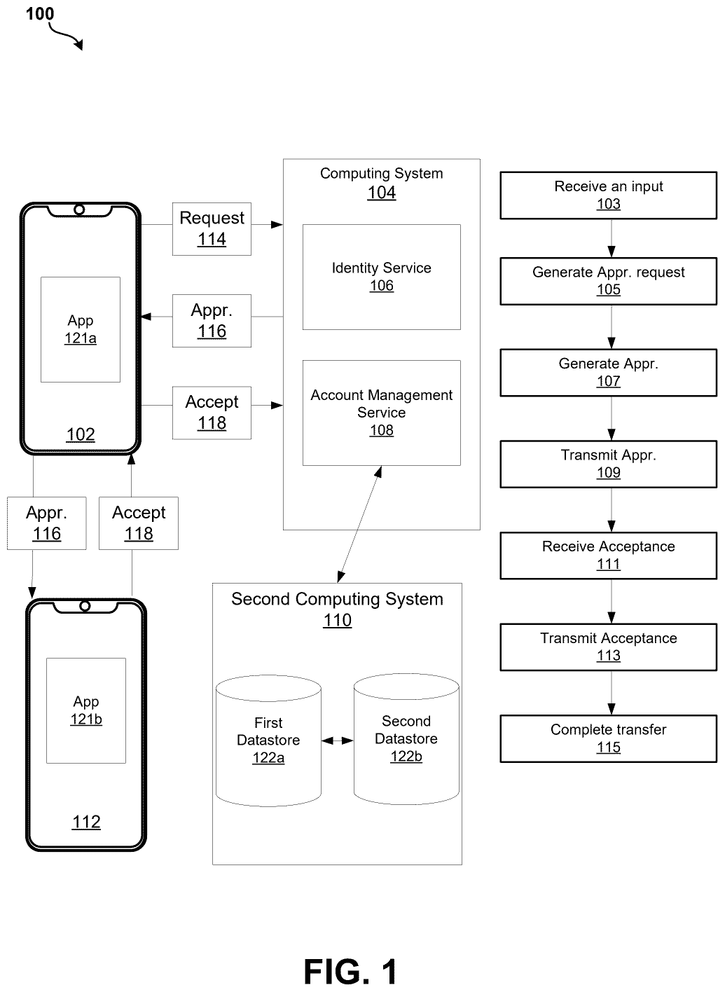

FIG. 1 illustrates a system 100 and a process 101 for performing an anonymous P2P data transfer, according to certain embodiments. The system 100 may include a sender device 102, a first computing system 104 with an identity service 106 and an account management service 108, and a second computing system 110 with a first datastore 122a and a second datastore 122b. The system 100 may also include a recipient device 112. Both the sender device 102 and the recipient device 112 may include applications 121a-b.

The sender device 102 may be a mobile device such as a smartphone, a tablet, a laptop, a wearable device, and/or any other suitable device. The sender device 102 may be associated with a first user (the sender), and include identifying information (e.g., a phone number, email address, account information, etc.) corresponding to the first user. Similarly, the recipient device 112 may be a mobile device such as a smartphone, a tablet, a laptop, a wearable device, and/or any other suitable device. The recipient device 112 may be associated with a second user (the recipient), and include identifying information (e.g., a phone number, email address, account information, etc.) corresponding to the second user. Both the sender device 102 and the recipient device 112 may be configured to communicate via one or more wireless protocols, such as NFC, WiFi, Bluetooth, and/or any other suitable protocol.

The sender device 102 may host an application 121a. The application 121a may be a data wallet or other similar application type. The application 121a may be associated with the user of the sender device 102 and include a ledger of data transfers made via the application 121a. The application 121a may also be associated with the first datastore 122a. For example, the first datastore 122a may be a data account associated with the user and connected to the application 121a. Thus, the application 121a may also include records of data transfers made via the first datastore 122a but not via the application 121a. Similarly, the recipient device 112 may host an application 121b. The application 121b may be another instance of the application 121a, but associated with the recipient instead of sender. The application 121b may be associated with the second datastore 122b (e.g., a data account associated with the recipient).

The application 121b may include a ledger of all data transfers made via the second datastore 122b and/or the application 121b.

The first computing system 104 may include one or more physical or virtual machines operating alone or in conjunction with one another. The first computing system 104 may be associated with the applications 121a-b and/or the sender device 102 and the recipient device 112. For example, the first computing system 104 may be a software and/or hardware developer for the sender device 102, the recipient device 112, and the applications 121a-b. Thus, the first computing system 104 may be configured to communicate with the devices 102 and 112 and/or the applications 121a-b without the involvement of the sender and/or recipient. For example, the sender device 102 and/or the application 121a may receive sensitive data not associated with the sender. The application 121a and/or some other service or application on the sender device 102 may store the sensitive data such that the sender may not access the sensitive data. The sensitive data may then be transmitted to the first computing system 104 and removed from the sender device 102. Similar operations may be performed by the recipient device 112.

The identity service 106 may include a hardware and/or software component configured to verify the identity and/or other account information associated with the sender device 102, the recipient device 112, and/or users thereof. The identity service 106 may be hosted by the first computing system 104 or may be hosted by a separate computing system (not shown). The identity service 106 may access one or more databases in order to authenticate requests or other data received from devices (e.g., the sender device 102). The identity service 106 may therefore be used to detect and/or reduce fraud such as fraudulent data transfer requests.

The account management service 108 may include a hardware and/or software component configured to process data transfer requests received from various devices (e.g., the sender device 102). For example, the account management service 108 may receive sensitive data related to a data transfer from the application 121a. The account management service 108 may then process the information and coordinate the data transfer between various datastores (e.g., the first datastore 122a and the second datastore 122b).

The second computing system 110 may be a third-party data storage and/or processing entity. The second computing system 110 may maintain one or more datastores associated with various users (e.g., the first datastore 122a and the sender, and the second datastore 122b and the recipient). The second computing system 110 may provide for a connection directly with the applications 121a-b, and/or may communicate with the applications 12la-b via the account management service 108. In the examples described below, transactional terms may be used. It should be understood that transactions are only one example of data transfers, and that the systems and methods below may be used to perform any type of data transfer.

At 103, the sender device 103 may receive an input via the application 121a indicating a desired data transfer. The application 121a may include a user interface through which the sender may input information associated with data transfers. For example, the application 121a may receive an input including an amount of money to be transferred from the first datastore 122a, indicating that the sender wishes to pay the amount to some other party. The input may not include, however, any indication of an intended recipient. In other words, the transaction associated with the input may be an anonymous transaction or data transfer.

At 105, the application 121a may generate a quote request 114. In some embodiments, the quote request 114 may be encrypted using a first public-private key pair shared between the first computing system 104 and the sender device 102 (and/or the application 121a). The quote request 114 may include a user ID (UID) associated with the sender device 102 (e.g., an IMEI number, a MAC address, or some other identifier), an ID associated with the sender (e.g., a name, phone number email, etc.), an account identifier (e.g., identifying the first datastore 122a), the amount indicated via the input, and/or other information.

The quote request 114 may then be transmitted to the first computing system 104. Upon receiving the quote request 114, the first computing system 104 may verify the data transfer request 114 using some or all of the information included therein. For example, the first computing system 104 may transmit the UID to the identity service 106. The identity service 106 may verify that the UID is associated with the sender device 102. The identity service 106 (and/or other services associated with the first computing system 104) may perform other checks such as a number of data transfer requests received from the sender device 102 in a given period of time. Thus, the first computing system 104 may verify that the data transfer request 114 is authentic (e.g., not fraudulent). The first computing system 104 may also verify that the amount indicated in the data transfer request 114 is available. For example, the account management service 108 may query the second computing system 110 to verify that the amount is accessible in the first datastore 122a (the first datastore 122a being associated with the sender device 102).

Upon verifying the data transfer request 114, at 107, the first computing system 104 may generate a transfer approval 116 (sometimes, a “quote”). The transfer approval 116 may include a quote ID, unique to the quote (e.g., the requested data transfer), the amount indicated in the data transfer request 114, and other information. The transfer approval 116 may be transmitted to the sender device 102 via the application 121a. The application 121a may enter a transfer mode. While in the transfer mode, the sender device 102 may search for various inputs associated with a recipient device. For example, the sender device 102 may activate one or more wireless circuits (e.g., an NFC circuit) such that data may be communicated with other devices via the wireless circuits. Then, the sender device 102 may be brought within a certain proximity of the recipient device 112. In response, the sender device 102 may connect to the recipient device 112 via the wireless circuits.

At 109, the sender device 102 may transmit some or all of the transfer approval 116 to the recipient device 112 via the connection described above. The transfer approval 116 may be received and/or processed by the application 121b. For example, the application 121b may determine a username or other identifier associated with the sender (e.g., a name the sender wishes to be public) and display a notification on the recipient device 112 with the username. The application 121b may also display the amount indicated in the transfer approval 116 and/or an input allowing the recipient to accept the data transfer.

In response to the input, the recipient device 112 may generate an acceptance packet 118. The acceptance packet 118 may also include a random transfer number, generated to identify the accepted data transfer. In some embodiments, the acceptance packet 118 may additionally or alternatively include the quote ID. In some embodiments, the acceptance packet 118 may additionally or alternatively include a random user ID, account information associated with the recipient device 112 and/or the recipient, an ID associated with the second datastore 122b, and other such information. The acceptance packet 118 may also include an identifier associated with the recipient (e.g., a name, image, etc. the recipient wishes to be public). Some or all of the acceptance packet 118 may be encrypted using the public key of the public-private key pair shared between the recipient device 112 (and the sender device) and the first computing system 104.

At 111, the sender device 102 may receive the acceptance packet 118 from the recipient device 112. The application 121a may receive and/or process the acceptance packet 118, displaying the public name of the recipient. The application 12la may also generate a confirmation input, wherein the recipient may confirm the amount of the data transfer and the public name.

Then, at 113, the sender device 102 (and/or the application 121a) may transmit the acceptance packet 118 (and/or the transfer approval 116) to the first computing system 104. The first computing system 104 may process the acceptance packet 118 (e.g., using the identity service 106 and/or other services) in order to complete the data transfer. At 115, the account management service 108 may utilize some or all of the data in the acceptance packet 118 to cause the second computing system 110 to complete the data transfer (e.g., to move the amount of data from the first datastore 122a to the second datastore 122b). The applications 121a-b may then generate corresponding confirmations and/or ledger entries. Neither the sender device 102 nor the recipient device 112 receives identifying information from the other party (at least in an unencrypted format). Thus, the data transfer may be completed anonymously, without any information being needed prior to the initiation of the data transfer.

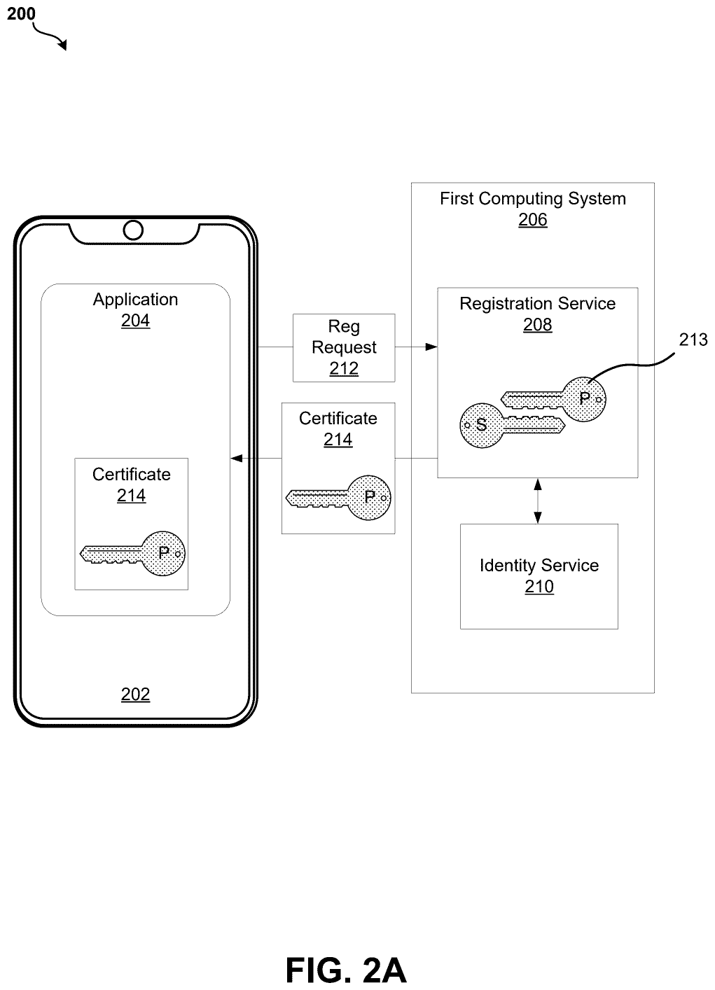

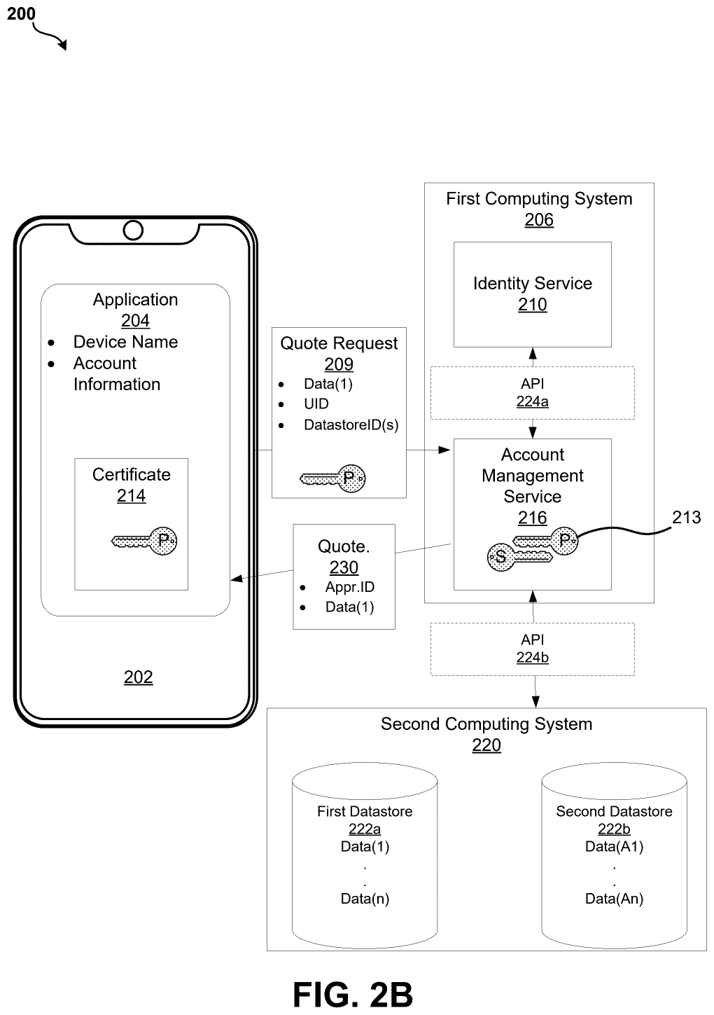

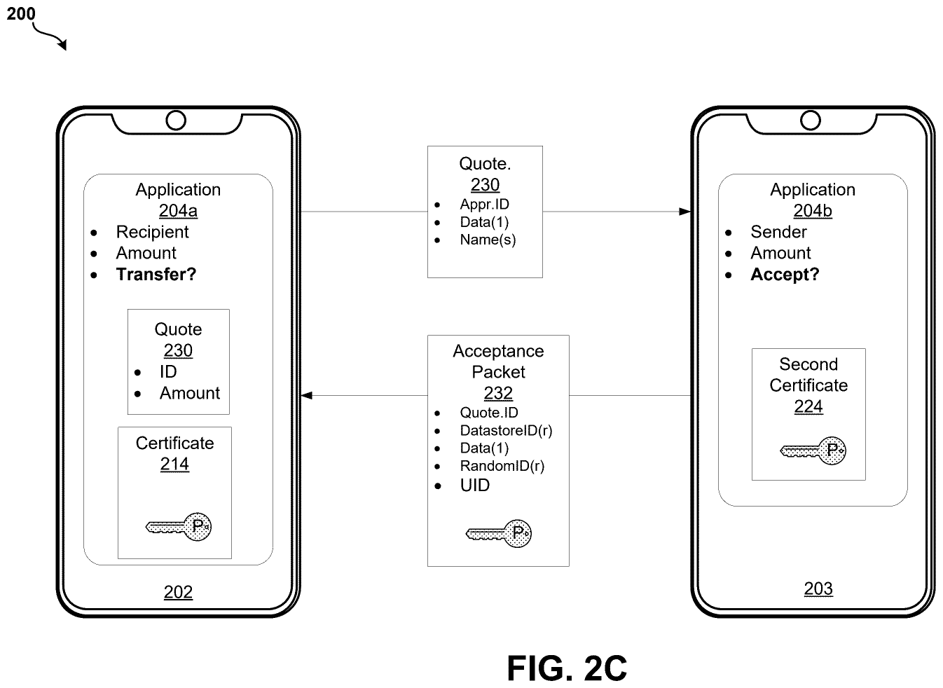

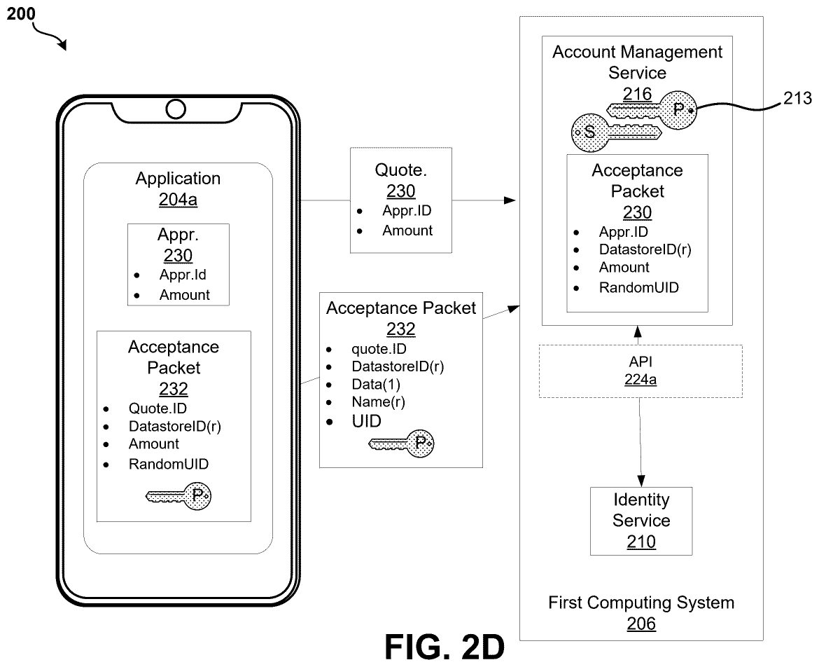

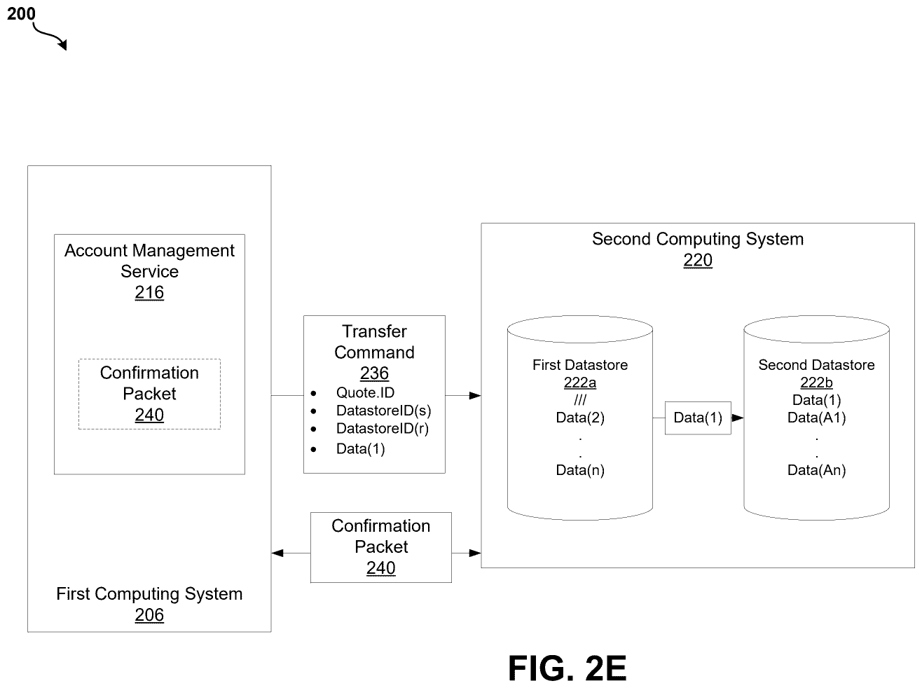

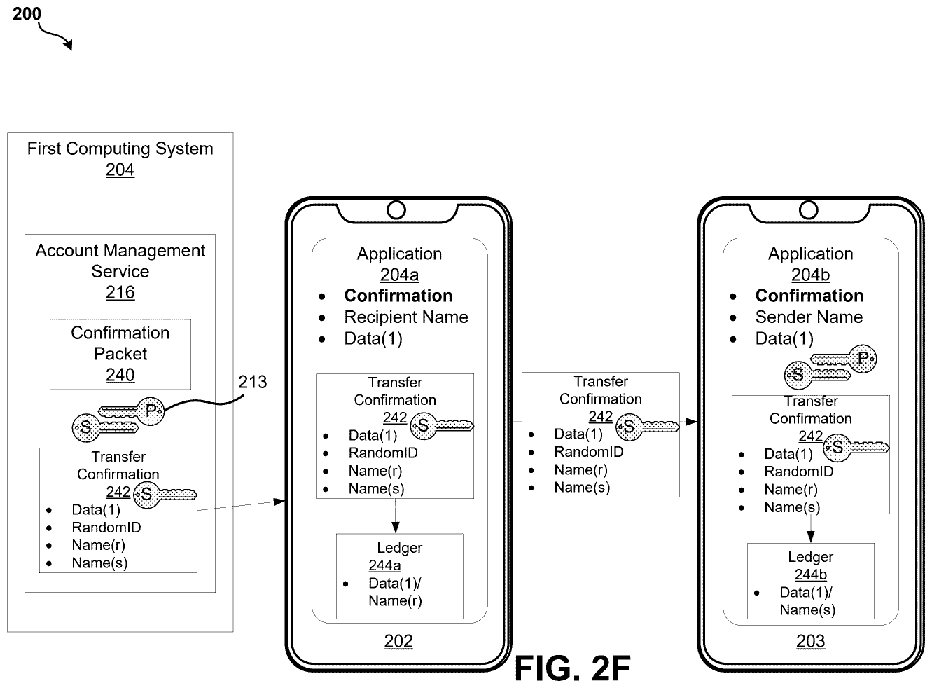

FIGS. 2A-2F illustrate a system 200 for performing an anonymous P2P data transfer, according to certain embodiments. FIG. 2A illustrates sender device 202 with an application 204 and a first computing system 206 with a registration service 208. The sender device 202 may be similar to the sender device 102 in FIG. 1. Thus, the sender device 202 may be a mobile device such as a smartphone, a tablet, a laptop, a wearable device, and/or any other suitable device. The sender device 202 may be associated with a sender and include identifying information (e.g., a phone number, email address, account information, etc.) corresponding to the sender. The application 204 may be similar to the application 121a and include similar features and functionalities.

The first computing system 206 may be similar to the first computing system 104 in FIG. 1. Thus, the first computing system 206 may include one or more physical or virtual machines operating alone or in conjunction with one another. The first computing system 206 may be associated with the application 121a and/or the sender device 202 (e.g., a software developer of the application 121a and/or a manufacturer of the sender device 202). The first computing system 206 may include a registration service 208 and an identity service 210. The registration service 208 may include one or more software and/or hardware components configured to enable the sender device 202 and/or the first computing system 206 to send and receive P2P data transfers. To do so, the registration service 208 may make one or more API calls to various other services, such as the identity service 210. The identity service 210 may be similar to the identity service 106 in FIG. 1, performing similar functions and operations.

The sender device 202 (and/or the application 204) may generate a registration request 212. The registration request 212 may include information such as a user ID of the sender, a device ID associated with the sender device 202, account information (e.g., identifying an associated datastore), and other such information. The registration service 208 may transmit some or all of the information to the identity service 210 in order to verify the information indicated in the registration request 212. For example, the registration service 208 may make an API call to the identity service 210 to verify the user ID and the device ID. Because the first computing system 206 may be associated with the sender device 202 (e.g., a manufacturer), the identity service 210 may access records indicating various devices and user IDs. Thus, the identity service 210 may verify that the user ID provided in the registration request 212 matches the device ID indicated in the records. One of ordinary skill in the art would recognize many different possibilities.

The registration service 208 may then store various information and/or make other API calls to other services. For example, the registration service 208 may link the datastore ID indicated in the registration request 212 to the device ID and/or the user ID in a database or other memory. Additionally or alternatively, the registration service 208 may provide the datastore ID, the device ID, and/or the user ID to another service (e.g., an account management service) and/or to a second computing system (e.g., the second computing system 110).

The registration service 208 may then generate a public-private key pair 213 to be shared with the sender device 202 (and/or other similar devices). The registration service 208 may then generate a certificate 214, signed with the public key of the public-private key pair 213. The registration service 208 may then transmit the certificate 214, including the public key, to the sender device 204 and/or the application 204. Because the public-private key pair is shared between the sender device 202 and the first computing system 206, the application 204 may provide encrypted information to the first computing system 206 such that only the first computing system 206 may access the encrypted information. Although FIG. 2A is described in relation to the sender device 202, any similar device may perform a registration process with the first computing system 206. Thus, a recipient device may perform the registration process, and be provided another certificate with the public key of the public-private key pair 213.

FIG. 2B illustrates the sender device 202 receiving a quote 230 for an anonymous P2P data transfer, according to certain embodiments. The sender device 202 may receive an input via the application 204 indicating a desired data transfer. For example, the sender may desire to make an anonymous P2P payment. The input may therefore indicate an amount to be paid. In some embodiments, the application 204 may be associated with one or more datastores (or accounts). The input may then also indicate a datastore to be involved with the data transfer.

In response, the application 204 may generate a transfer request 209. The transfer request 209 may include the amount, the datastore ID of the sender (datastoreID(s)), the UID associated with the sender, and other information (e.g., a device ID etc.). In some embodiments, the transfer request 209 may be encrypted by the application 204 using the public key of the public-private key pair 213. Thus, only the first computing system 206 (and/or components thereof) may access the data included in the transfer request 209. In other embodiments, the quote request 209 may be sent in plaintext.

The transfer request 209 may be transmitted by the sender device 202 to the first computing system 206. The transfer request 209 may be received and/or processed, in whole or in part, by an account management service 216. The account management service 216 may be similar to the account management service 108 in FIG. 1. The account management service 216 may access the public-private key pair 213 to decrypt some or all of the transfer request 209. The account management service 216 may make one or more API calls to various other systems and/or services to process the transfer request 209.

For example, the account management service 216 may access the identity service 210 via an API 224a. The account management service 216 may provide the UID, the device ID, and/or other information included in the transfer request 209 to the identity service 210 in order to verify the authenticity of the transfer request 209. The identity service 210 may access one or more databases to determine whether the information provided via the API 224a matches records stored in the databases. If the records do not match, the identity service 210 may transmit a fraud alert to the account management service 216 and/or the sender device 202. If the records do match, the identity service 210 may indicate that the transfer request 209 is authentic via the API 224a.

After verifying the authenticity of the transfer request 209, the account management service 216 may access a second computing system 220 via an API 224b. The second computing system 220 may be similar to the second computing system 110 in FIG. 1. The second computing system 220 may include 222a-b. The datastore 222a may be an account associated with the sender. Via the API 224b, the account management service 216 may verify that the amount (or other data) indicated in the transfer request 209 is available within the first datastore 222a. For example, the transfer request 209 may indicate that the sender device 202 is to transfer data(1). The account management service 216, via the API 224b, may then verify that the first datastore 222a includes the data(1). In the example where the desired data transfer is an anonymous payment, the account management service 216 may verify that an account (e.g., the first datastore 222a) has the amount of money indicated in the transfer request 209.

Upon verifying the data indicated in the transfer request 209, the account management service 216 (or some other service of the first computing system 206) may generate a quote 230. The quote 230 may include a unique quote ID. The quote 230 may also include the data indicated in the transfer request 209. In some embodiments, the quote 230 may be encrypted using the public-private key pair 213. The quote 230 may then be transmitted to the sender device 202 and received by the application 204.

FIG. 2C illustrates the sender device initiating a P2P data transfer with a recipient device 203, according to certain embodiments. The recipient device 203 may be similar to the sender device 202 and include similar components and functionalities. However, the recipient device 203 may be associated with a different user (sometimes, the “recipient”). Thus, the recipient device 203 may include identifying information associated with the recipient. The recipient device 203 may include an application 204b, similar to the application 204a. However, instead of being associated with the datastore 222a, the application 204b may be associated with the datastore 222b (in FIG. 2B).

After receiving the quote 230 from the first computing system 206, the sender device 202 and/or the application 204a may enter a transfer mode. The transfer mode may activate one or more wireless circuits to enable P2P data transfers. The transfer mode may also include a scanning mode, wherein the sender device 202 scans for available recipient devices (e.g., the recipient device 203). For example, while in the transfer mode, the sender device 202 may enable an NFC circuit, and scan for other NFC circuits associated with the application 204a (e.g., the application 204b). When the sender device 202 is brought within a certain proximity of the recipient device 203, the sender device 202 may initiate a wireless connection with the recipient device 203 via NFC. The sender device 202 may then connect to the recipient device 203 via Wifi, Bluetooth, or any other suitable wireless protocol.

The sender device 202 may then transmit some or all of the quote 230 to the recipient device 203. The quote 230 may include the quote ID, identifying the desired data transfer and the amount indicated in the transfer request 209. The quote 230 may also include a public name, chosen by the sender to be public. For example, during the registration process in FIG. 2A, the sender may provide a public name to the application 204a. The public name may be an identifier that the sender is comfortable with being public (e.g., a nickname, a first name, etc.). In some embodiments, a photo, image, or other graphical representation (e.g., a GIF, etc.) may also be included with the public name. In some embodiments, the application 204a may generate a random username to display during anonymous P2P data transfers.

The application 204b may receive and/or process some or all of the quote 230. The application 204b may display the public name of the sender and the amount (or data) indicated in the quote 230. The application 204b may display a user prompt, asking the recipient to accept the data transfer as indicated in the quote 230.

In response to an input indicating that the recipient accepts the data transfer, the application 204b may generate an acceptance packet 232. The acceptance packet 232 may include a random ID. The random ID may be a random number generated by the application 204b and associated with the data transfer indicated in the quote 230. The acceptance packet 232 may also include the quote ID, a datastore ID associated with the recipient (e.g., the datastore 222b), the amount (or data) indicated in the quote 230, and a public name of the recipient. Similar to the public name of the sender, the public name may be an identifier that the recipient is comfortable with being public (e.g., a nickname, a first name, etc.). In some embodiments, the application 204b may generate a random username to display during anonymous P2P data transfers. Some or all of the acceptance packet 232 may be encrypted with the public key of the public-private key pair 213. The recipient device 203 may receive a second certificate 224, signed with the public-private key pair 213 during a registration process, similar to that described in FIG. 2A. As the acceptance packet 232 is encrypted with the public key of the public-private key pair 215, only the first computing system 206 may access the data included in some or all of the acceptance packet 232.

The acceptance packet 232 may be transmitted by the application 204b on the recipient device 203 to the application 204a on the sender device 202 via the wireless connection (or any other suitable connection for P2P data transfers) initiated via NFC. The application 204a may receive and process some or all of the acceptance packet 232. For example, the public name (or other identifier) of the recipient may not be encrypted. The application 204a may then access the public name of the recipient. Similarly, the quote ID may not be encrypted. Thus, the application 204a may verify that the quote ID indicated in the quote 230 matches the quote ID indicated in the acceptance packet 232. Then, the application 204a may generate a display of the public name of the recipient and the amount (or other data) indicated in the quote 230 and the acceptance packet 232. The application 204a may also generate a user prompt, prompting the sender for confirmation of the data transfer.

Although the acceptance packet 232 may include identifying information (or other sensitive data) associated with the recipient, some or all of the acceptance packet 232 may be encrypted with the public key of the public-private key pair 213. The sender device 202, however, may only include the public key of the public-private key pair 213, and thus be unable to access any identifying information. Therefore, even though the P2P data transfer may include the transfer of identifying information, both parties may remain anonymous.

FIG. 2D illustrates the sender device 202 transmitting the quote 230 and the acceptance packet 232 to the first computing system 206. Although FIG. 2D illustrates the quote 230 and the acceptance packet 232 being transmitted separately, some or all of the quote 230 and some or all of the acceptance packet 232 may be included in a single datablob and transmitted to the first computing system 206. In either case, some or all of the acceptance packet 232 may be encrypted with the public key of the public-private key pair 213. The quote 230 and the acceptance packet 232 may be received by the account management service 216 (and/or some other service on the first computing system 206). The account management service 216 may access the public-private key pair 213 in order to access some or all of the information included in the acceptance packet 232.

The account management service 216 may then verify some or all of the information included in the acceptance packet 232. For example, the account management service 216 may make an API call via the API 224a to the identity service 210 to verify a user ID and/or device ID associated with the acceptance packet 232. Because the first computing system 206 may be associated with the recipient device 203 (e.g., a manufacturer), the identity service 210 may access records indicating various devices and user IDs. Thus, the identity service 210 may verify that the user ID provided in the acceptance packet 232 matches the device ID indicated in the records. One of ordinary skill in the art would recognize many different possibilities.

FIG. 2E illustrates the first computing system 206 transmitting a transfer command 236 to the second computing system 220, according to certain embodiments. After verifying some or all of the information included in the acceptance packet 232, the account management service 216 (or some other service) may generate the transfer command 236. The transfer command 236 may be based at least in part on the quote 230 and/or the acceptance packet 232. The transfer command 236 may include the quote ID, the datastore ID of the sender (e.g., the first datastore 222a), the datastore ID of the recipient (e.g., the second datastore 222b), an indication of the data to be transferred (and/or an amount), and/or other information. The transfer command 236 may be transmitted to the second computing system 220 via the API 224b and/or some other API or appropriate means. In some embodiments, the transfer command 236 may include a certificate of other cryptographic device used to verify that the transfer command is authentic (e.g., generated by the first computing system 206).

The second computing system 220 may perform the data transfer according to the transfer command. As seen in FIG. 2E, the transfer command 236 may indicate that “Data(1)” is to be transferred from the first datastore 222a (e.g., datastoreID(s)) to the second datastore 222b (e.g., datastoreID(r)). The second computing system 220 may then cause the data(1) to be removed from the first datastore 222a and stored in the second datastore 222b. After performing the data transfer, the second computing system 220 may generate a confirmation packet 240. The confirmation packet 240 may include the datastore IDs, the quote ID, and the data indicated in the transfer command 236. The confirmation packet 240 may be received and/or processed by the account management service 216. The account management service 216 may verify that information indicated in the confirmation packet 240 matches the information indicated in the quote 230 and/or the acceptance packet 232.

FIG. 2F illustrates the first computing system 206 generating a transfer confirmation confirmation 242 and transmitting the transfer confirmation 242 to the sender device 202, according to certain embodiments. After verifying the confirmation packet 240, the account management service 216 may generate the transfer confirmation 242. The transfer confirmation 242 may indicate the public name of the sender (Name(s)), the name of the recipient (Name(r)), the transferred data (Data(1)), and/or other information. Whereas the confirmation packet 240 may include identifying information and/or other sensitive data (e.g., device IDs, user IDs, datastore IDs, etc.), the transfer confirmation 242 may only include shared information. Although the information included in the transfer confirmation 242 may not include sensitive data, the account management service 216 (or some other service of the first computing system 206) may cryptographically sign the transfer confirmation 242 using the secret key of the public-private key pair 215. Because the transfer confirmation 242 may include the random ID, generated by the application 204b, the recipient device 203 may be guaranteed that the data transfer performed is the same data transfer the acceptance packet was generated for.

The first computing system 206 may then transmit the transfer confirmation 242 to the sender device 202 and/or the application 204a. The application 204a may receive and/or process some or all of the transfer confirmation 242. For example, the application 204a may determine that the data transfer has been completed and generate a confirmation notification for display. The confirmation notification may indicate the transferred data (e.g., Data(1)) and the public name of the recipient. The application 204a may also generate an entry in a ledger 244a, indicating the transferred data and the recipient's public name. Thus, the application 204a may include a record of the anonymous P2P data transfer.

The sender device 202 (and/or the application 204a) may transmit the transfer confirmation 242 to the recipient device 203 (and/or the application 204b) via the NFC connection (or other wireless connection). The application 204 may then verify the transfer confirmation 242 using the public key of the public-private key pair 213. Because the transfer confirmation 242 is signed using the secret key of the public-private key pair 213, the recipient device 203 may trust that the transfer confirmation 242 is generated by the first computing system 206 (and/or systems thereof) and is unmodified by the sender device 202. Also, Because the transfer confirmation 242 may include the random ID, generated by the application 204b, the recipient device 203 may be guaranteed that the data transfer performed is the same data transfer the acceptance packet was generated for. Therefore, the recipient device 203 may determine that the P2P data transfer indicated in the quote 230 was actually performed and confirmed by the first computing system 206. The application 204b may then generate an entry in a ledger 244b, indicating the transferred data and the sender's public name. Thus, the P2P data transfer may be performed between the sender device 202 and the recipient device 203 without the exchange of identifying information and/or other sensitive data. Furthermore, the anonymous P2P transfer may be performed without the sender and/or the recipient having any prior knowledge of the other party.

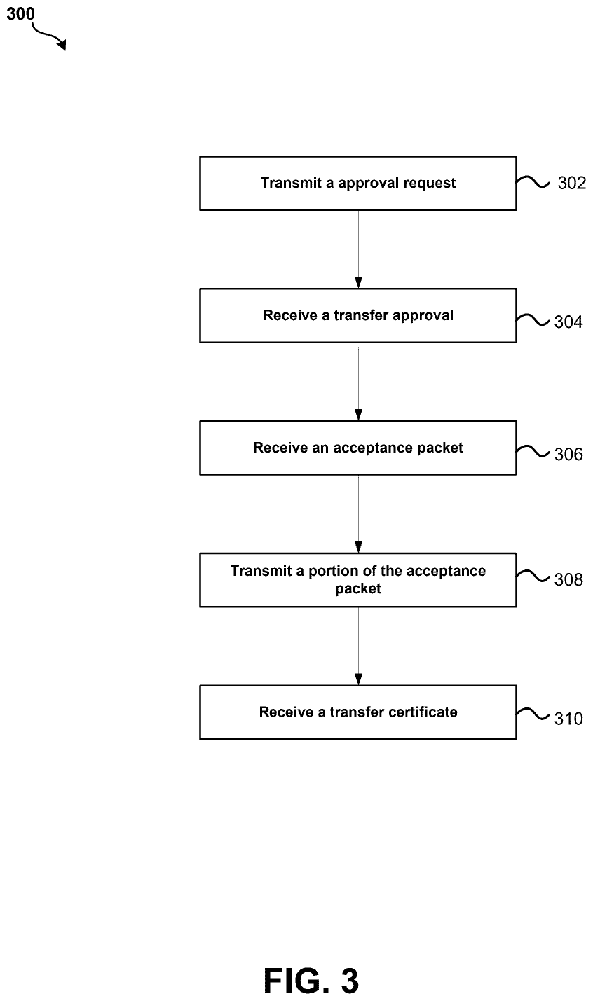

FIG. 3 illustrates a flowchart of a method 300 for performing an

anonymous P2P data transfer, according to certain embodiments. The method 300 may be performed by some or all of the systems and devices described herein, such as the systems 100 and 200 in FIGS. 1 and 2, respectively. In some embodiments, one or more steps of the method 300 may be performed in a different order than is described and/or be combined with other steps. In some embodiments, some steps may be skipped altogether.

At step 302, the method 300 may include transmitting, by an application executed on a user device, a transfer request associated with a desired data transfer to a first computing system. The user device may be similar to the sender device 202 in FIG. 2B. The transfer request may include a sender ID, such as a user ID, a device ID, etc. The transfer request may also indicate specific data to be transferred, and amount to be transferred, and/or other such information. The first computing system may include one or more services such as the identity service 106 and the account management service 108 in FIG. 1. The one or more services may be accessed via respective APIs and enable the first computing system to authenticate and process requests. The first computing system may also access a second computing system via an API in order to determine the viability of the desired data transfer.

At step 304, the method 300 may include receiving, by the application executed on the user device, a transfer approval from the first computing system. The transfer approval may indicate that the desired data transfer is approved. For example the account management service may access the identity service via an API. The account management service may provide the UID, the device ID, and/or other information included in the transfer request to the identity service in order to verify the authenticity of the transfer request. The identity service may access one or more databases to determine whether the information provided via the API matches records stored in the databases. If the records do not match, the identity service may transmit a fraud alert to the account management service and/or the user device. If the records do match, the identity service may indicate that the transfer request is authentic via the API. Thus, the first computing system may generate the transfer approval and transmit the transfer approval to the user device.

At step 306, the method 300 may include receiving, by the application executed on the user device, an acceptance packet from a recipient device. The acceptance packet may indicate that the desired data transfer is accepted and include a recipient ID (e.g., the public name of the recipient). For example, the acceptance packet may be similar to the acceptance packet 232 in FIG. 2C. The acceptance packet may include a quote ID, a datastore ID associated with the recipient (e.g., the datastore 222b), the amount (or data) indicated in the transfer approval, and a public name of the recipient. The public name may be an identifier that the recipient is comfortable with being public (e.g., a nickname, a first name, etc.). In some embodiments, an application executed on the recipient device may generate a random user name to display during anonymous P2P data transfers. Some or all of the acceptance packet may be encrypted with the public key of the public-private key pair 213. The recipient device may receive a certificate with the public-private key pair 213 during a registration process, similar to that described in FIG. 2A.

At step 308, the method 300 may include transmitting, by the application executed on the user device, at least a portion of the acceptance packet to the first computing system. The user device may additionally or alternatively transmit some or all of the transfer approval to the first computing system. Upon receiving the acceptance packet and/or the transfer approval, the first computing system may decrypt some or all of the acceptance packet and/or the transfer approval to access data included therein. The first computing system may then verify some or all of the data. The first computing system may then cause the data transfer to be performed (e.g., by sending a transfer command to the second computing system).

The first computing system may then generate a transfer confirmation similar to the transfer confirmation 242 in FIG. 2E. The transfer confirmation may indicate the public name of the sender, the name of the recipient, the transferred data, and/or other information. The transfer confirmation may only include shared information. Although the information included in the transfer confirmation may not include sensitive data, the first computing system may cryptographically sign the transfer confirmation using the secret key of the public-private key pair.

At 310, the method 300 may include receiving, by the application executed on the user device, the transfer confirmation, confirming that the desired data transfer is based on the acceptance packet and/or the transaction quote. The application may receive and/or process some or all of the transfer confirmation. For example, the application may determine that the data transfer has been completed and generate a confirmation notification for display. The confirmation notification may indicate the transferred data and the public name of the recipient. The application may also generate an entry in a ledger, indicating the transferred data and the recipient's public name.

The sender device may transmit the transfer confirmation to the recipient device via an NFC connection (or other wireless connection). An application executed on the recipient device may then verify the transfer confirmation using the public-private key pair 213. Because the transfer confirmation is signed using the public-private key pair 213, the recipient device may trust that the transfer confirmation is generated by the first computing system (and/or services thereof) and is unmodified by the sender device. Therefore, the recipient device may determine that the P2P data transfer indicated in the quote was actually performed and confirmed by the first computing system. Also, because the recipient device may receive the transfer confirmation from the sender device, the recipient device may not be connected to any network during the data transfer, and still receive confirmation of the data transfer. The application may then generate an entry in a ledger, indicating the transferred data and the sender's public name. Thus, the P2P data transfer may be performed between the sender device and the recipient device without the exchange of identifying information and/or other sensitive data. Furthermore, the anonymous P2P transfer may be performed without the sender and/or the recipient having any prior knowledge of the other party.

In some embodiments, the method 300 may include transmitting, by the application executed on the user device, a registration request to the first computing system (e.g., the registration request 212 in FIG. 2A. The method 300 may also include receiving, by the application executed on the user device, a user certificate signed with a first public-private key pair. The user certificate may be similar to the certificate 214. A similar process may be performed by the recipient device, as described herein.

In some embodiments, the method 300 may include transmitting, by the first computing system via a first application programming interface (API) (e.g., the API 224a), a sender ID to an authentication service. The sender ID may be similar to the user ID in the transfer request 209. The method 300 may also include receiving, by the first computing system via the first API, a validation response from the authentication service. The method may also include transmitting, by the first computing system via a second API (e.g., the API 224b), the transfer request to a second computing system. The method 300 may also include receiving, by the first computing system via the second API, an approval response from the second computing system.

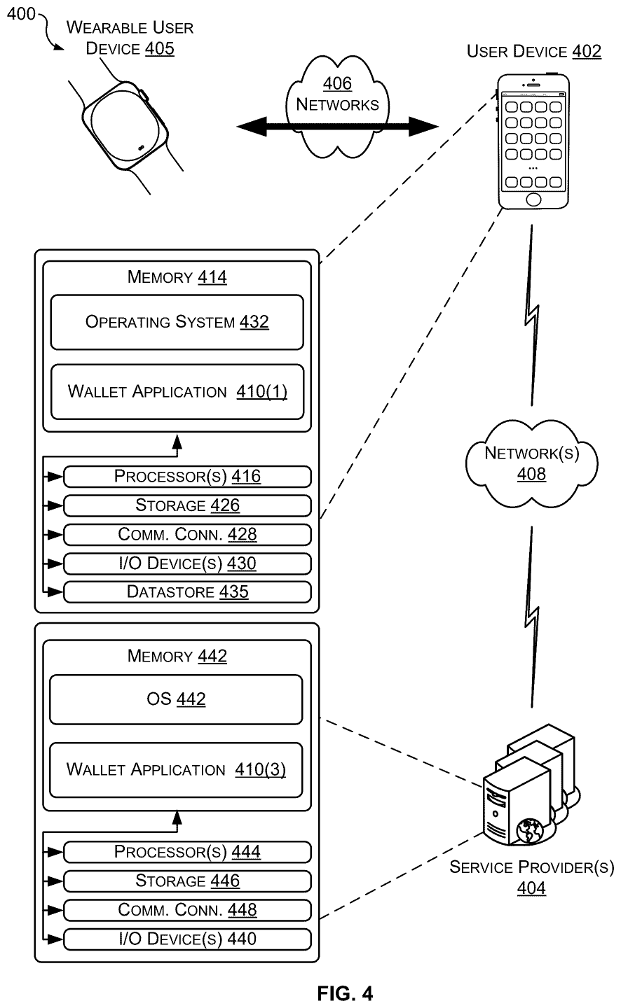

FIG. 4 illustrates an example architecture or environment 400 configured to implement techniques relating to providing route management, according to certain embodiments. In some examples, the example architecture 400 may further be configured to enable a user device 402 (e.g., the user device 102), the service provider computers 404 (e.g., the service provider 404), and a wearable electronic device 405 (e.g., an example accessory deice) to share information. In some examples, the devices may be connected via one or more networks 408 and/or 406 (e.g., via Bluetooth, WiFi, the Internet, or the like). In the architecture 400, one or more users may utilize the user device 402 to manage, control, or otherwise utilize the wearable electronic device 405, via the one or more networks 406. Additionally, in some examples, the wearable electronic device 405, the service provider computers 404, and the user device 402 may be configured or otherwise built as a single device. For example, the wearable electronic device 405 and/or the user device 402 may be configured to implement the examples described herein as a single computing unit, exercising the examples described above and below without the need for the other devices described.

In some examples, the networks 406, 408 may include any one or a combination of many different types of networks, such as cable networks, the Internet, wireless networks, cellular networks, satellite networks, other private and/or public networks, or any combination thereof. While the illustrated example represents the user device 402 accessing the service provider computers 404 via the networks 408, the described techniques may equally apply in instances where the user device 402 interacts with the service provider computers 404 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

The user device 402 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 402 may be in communication with the service provider computers 404 via the networks 408, 406, or via other network connections.

In one illustrative configuration, the user device 402 may include at least one memory 414 and one or more processing units (or processor(s)) 416. The processor(s) 416 may be implemented as appropriate in hardware, computer-executable instructions, firmware, or combinations thereof. Computer-executable instruction or firmware implementations of the processor(s) 416 may include computer-executable or machine-executable instructions written in any suitable programming language to perform the various functions described. The user device 402 may also include geo-location devices (e.g., a global positioning system (GPS) device or the like) for providing and/or recording geographic location information associated with the user device 402.

The memory 414 may store program instructions that are loadable and executable on the processor(s) 416, as well as data generated during the execution of these programs. Depending on the configuration and type of the user device 402, the memory 414 may be volatile (such as random access memory (RAM)) and/or non-volatile (such as read-only memory (ROM), flash memory, etc.). The user device 402 may also include additional removable storage and/or non-removable storage 426 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 414 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 414 and the additional storage 426, both removable and non-removable, are all examples of non-transitory computer-readable storage media. For example, non-transitory computer readable storage media may include volatile or non-volatile, removable or non-removable media implemented in any process or technology for storage of information such as computer-readable instructions, data structures, program modules, or other data. The memory 414 and the additional storage 426 are both examples of non-transitory computer storage media. Additional types of computer storage media that may be present in the user device 44 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 402. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 402 may also contain communications connection(s) 428 that allow the user device 402 to communicate with a data store, another computing device or server, user terminals, and/or other devices via the networks 408, 406. The user device 402 may also include I/O device(s) 430, such as a keyboard, a mouse, a pen, a voice input device, a touch input device, a display, an operating system 432 and/or one or more application programs or services for implementing the features disclosed herein including a map application 410(1). In some examples, the map application 410(1) may be configured to implement the features described herein such as those described with reference to the flowcharts. User device 402 may also include a Datastore 435. The Datastore 435 may be a separate memory partition within the memory 414 or may be an individual hardware component of the user device 402. The Datastore 435 may be configured as a sensitive data Datastore, and may not be accessible to a user of the user device 402.

The service provider computers 404 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 404 may be in communication with the user device 402 and/or the wearable user device 405 via the networks 408, 406, or via other network connections.

In one illustrative configuration, the service provider computers 404 may include at least one memory 442 and one or more processing units (or processor(s)) 444. The processor(s) 444 may be implemented as appropriate in hardware, computer-executable instructions, firmware, or combinations thereof. Computer-executable instruction or firmware implementations of the processor(s) 444 may include computer-executable or machine-executable executable instructions written in any suitable programming language to perform the various functions described.

The memory 442 may store program instructions that are loadable and executable on the processor(s) 444, as well as data generated during the execution of these programs. Depending on the configuration and type of service provider computer 404, the memory 442 may be volatile (such as RAM) and/or non-volatile (such as ROM, flash memory, etc.). The service provider computer 404 may also include additional removable storage and/or non-removable storage 446 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 442 may include multiple different types of memory, such as SRAM, DRAM, or ROM. While the volatile memory described herein may be referred to as RAM, any volatile memory that would not maintain data stored therein once unplugged from a host and/or power would be appropriate.

The memory 442 and the additional storage 446, both removable and non-removable, are both additional examples of non-transitory computer-readable storage media.

The service provider computer 404 may also contain communications connection(s) 448 that allow the service provider computer 404 to communicate with a data store, another computing device or server, user terminals and/or other devices via the networks 408, 406. The service provider computer 404 may also include I/O device(s) 440, such as a keyboard, a mouse, a pen, a voice input device, a touch input device, a display, speakers, a printer, etc. The memory 442 may include an operating system 442 and/or one or more application programs or services for implementing the features disclosed herein including the map sync 410(3). This version of the sensitive data application may be configured to perform similar operations as the map application 410(1). Thus, in some examples, the map sync 410(3) may be configured to implement the features described herein such as those described with reference to the flowcharts.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C #or C++, or any scripting language, such as Perl, Python or TCL, as well as combinations thereof. The server(s) may also include database servers, including without limitation those commercially available from Oracle®, Microsoft®, Sybase®. and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from specific and legitimate sources to improve routing of stored routes by checking if they are navigable. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information. The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of customized routes, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app related to navigation or downloading routes that their personal information data may be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain financial applications, data de-identification can be used to protect a user's privacy and/or sensitive data. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method of performing an anonymous data transfer, comprising:
transmitting, by an application executed on a user device, a transfer request associated with a desired data transfer to a first computing system, the transfer request comprising a sender identifier (ID);
receiving, by the application executed on the user device, a transfer approval from the first computing system, the transfer approval indicating that the desired data transfer is approved;
receiving, by the application executed on the user device, an acceptance packet from a recipient device, the acceptance packet indicating that the desired data transfer is accepted and comprising a recipient ID;
transmitting, by the application executed on the user device, at least a portion of the acceptance packet to the first computing system; and
receiving, by the application executed on the user device, a transfer confirmation confirming that the desired data transfer is based at least in part on the acceptance packet and/or the transfer approval.

2. The method of claim 1, wherein the transfer approval comprises the sender ID, the method further comprising:
transmitting, by the first computing system via a first application programming interface (API), the sender ID to an authentication service;
receiving, by the first computing system via the first API, a validation response from the authentication service;
transmitting, by the first computing system via a second API, the data transfer request to a second computing system; and
receiving, by the first computing system via the second API, an approval response from the second computing system.

3. The method of claim 1, further comprising:
transmitting, by the application executed on the user device, a registration request to the first computing system; and
receiving, by the application executed on the user device, a user certificate signed with a public key of a public-private key pair.

4. The method of claim 3, wherein the acceptance packet is encrypted with the public key of the public-private key pair, the method further comprising:
decrypting, by the first computing system, the acceptance packet using a private key of the public-private key pair;
validating, by the first computing system, the recipient ID via one or more APIs; and
in response to validating the recipient ID, performing the desired data transfer.

5. The method of claim 1, further comprising:
determining, by the application executed on the user device, a public ID associated with the recipient device, based at least in part on the acceptance packet;
generating, by the application executed on the user device, a confirmation notification indicting the public ID associated with the associated recipient device; and
displaying, by the application executed on the user devices, the confirmation notification.

6. The method of claim 1, wherein the transfer approval comprises a quote ID.

7. The method of claim 1, further comprising:
receiving, by the application executed on the user device, a transfer confirmation from the first computing system, the transfer confirmation comprising a random ID and a transfer signature signed with the private key of a public-private key pair;
transmitting, by the application executed on the user device, the transfer signature to the recipient device; and
decrypting, by a recipient application executed on the recipient device, the transfer signature using a public key of the public-private key pair to verify the random ID.

8. A system for performing anonymous data transfers, the system comprising:
one or more processors; and
a computer-readable medium comprising instructions that, when executed by the one or more processors, cause the one or more processors to perform operations to:
transmit, by an application executed on a user device, a transfer request associated with a desired data transfer to a first computing system, the transfer request comprising a sender ID;
receive, by the application executed on the user device, a transfer approval from the first computing system, the transfer approval indicating that the desired data transfer is approved;
receive, by the application executed on the user device, an acceptance packet from a recipient device, the acceptance packet indicating that the desired data transfer is accepted and comprising a recipient ID;
transmit, by the application executed on the user device, at least a portion of the acceptance packet to the first computing system; and
receive, by the application executed on the user device, a transfer confirmation confirming that the desired data transfer is based at least in part on the acceptance packet and/or the transfer approval.

9. The system of claim 8, wherein the user device and the recipient device communicate via a wireless connection initiated via near field communication.

10. The system of claim 8, wherein the anonymous data transfer is a peer-to-peer data transfer.

11. The system of claim 8, wherein the acceptance packet is encrypted with a public key of the public-private key pair and the system further performs operations to:
decrypt, by the first computing system, the acceptance packet using a private key of the public-private key pair;
validate, by the first computing system, the recipient ID via one or more APIs; and
in response to validating the recipient ID, perform the desired data transfer.

12. The system of claim 8, wherein the quote comprises the sender ID, and the system further performs operations to:
transmit, by the first computing system via a first application programming interface (API), the sender ID to an authentication service;
receive, by the first computing system via the first API, a validation response from the authentication service;
transmit, by the first computing system via a second API, the data transfer request to a second computing system; and
receive, by the first computing system via the second API, an approval response from the second computing system.

13. The system of claim 8, wherein the system further performs operations to:
transmit, by the application executed on the user device, a registration request to the first computing system; and
receive, by the application executed on the user device, a user certificate signed with a public-private key pair.

14. The system of claim 8, wherein the system further performs operations to:
determine, by the application executed on the user device, a public ID associated with the recipient device, based at least in part on the acceptance packet;
generate, by the application executed on the user device, a confirmation notification indicting the public ID associated with the associated recipient device; and
display, by the application executed on the user device, the confirmation notification.

15. A non-transitory computer-readable medium comprising instructions that, when executed by one or more processors, cause the one or more processors to perform operations comprising:
transmitting, by an application executed on a user device, a transfer request associated with a desired data transfer to a first computing system, the transfer request comprising a sender ID;
receiving, by the application executed on the user device, a transfer approval from the first computing system, the transfer approval indicating that the desired data transfer is approved;
receiving, by the application executed on the user device, an acceptance packet from a recipient device, the acceptance packet indicating that the desired data transfer is accepted and comprising a recipient ID;
transmitting, by the application executed on the user device, at least a portion of the acceptance packet to the first computing system; and
receiving, by the application executed on the user device, a transfer confirmation confirming that the desired data transfer is based at least in part on the acceptance packet and/or the transfer approval.

16. The non-transitory computer-readable medium of claim 15, wherein the quote comprises the sender ID, the operations further comprising:
transmitting, by the first computing system via a first application programming interface (API), the sender ID to an authentication service;
receiving, by the first computing system via the first API, a validation response from the authentication service;
transmitting, by the first computing system via a second API, the data transfer request to a second computing system; and
receiving, by the first computing system via the second API, an approval response from the second computing system.

17. The non-transitory computer-readable medium of claim 15, the operations further comprising:
transmitting, by the application executed on the user device, a registration request to the first computing system; and
receiving, by the application executed on the user device, a user certificate signed with a public key of a public-private key pair.

18. The non-transitory computer-readable medium of claim 15, the operations further comprising:
determining, by the application executed on the user device, a public ID associated with the recipient device, based at least in part on the acceptance packet;
generating, by the application executed on the user device, a confirmation notification indicting the public ID associated with the associated recipient device; and
displaying, by the application executed on the user devices, the confirmation notification.

19. The non-transitory computer-readable medium of claim 15, wherein the acceptance packet is encrypted with a public key of a public-private key pair, the operations further comprising:
decrypting, by the first computing system, the acceptance packet using a private key of the public-private key pair;
validating, by the first computing system, the recipient ID via one or more APIs; and
in response to validating the recipient ID, performing the desired data transfer.

20. The non-transitory computer-readable medium of claim 15, wherein the transfer approval comprises a quote ID.
